(19) United States
(12) Patent Application Publication
(10) Pub. No.: US 2010/0075739 A1
(43) Pub. Date: Mar. 25, 2010

(54) GAMING SYSTEM AND A METHOD OF GAMING

(75) Inventor: George Roukis, Miranda (AU)

Correspondence Address: MCANDREWS HELD & MALLOY, LTD, 500 WEST MADISON STREET, SUITE 3400, CHICAGO, IL, 60661, US

(73) Assignee: ARISTOCRAT TECHNOLOGIES AUSTRALIA PTY LIMITED, Lane Cove (AU)

(21) Appl. No.: 12/249,491

(22) Filed: Oct. 10, 2008

(30) Foreign Application Priority Data
Oct. 11, 2007 (AU) 2007905577

(51) Int. Cl. A63F 9/24; A63F 13/00

(52) U.S. Cl. 463/20; 463/25; 463/30; 463/43

(57) ABSTRACT

A method of gaming comprising: providing a plurality of display positions; selecting a plurality of symbols for display at the display positions; evaluating the symbols to determine whether to make a first award based on a designated number of a designated symbol in a winning combination such that the first award is independent of the positions of the designated symbols in the winning combination; and upon a prize being awarded in respect of a winning combination, evaluating the symbols of the winning combination to determine whether to make a second, additional award based on the arrangement of the designated symbols within the winning combination.

### RELATED APPLICATIONS

This application claims priority to Australian Provisional Patent Application No. 2007905577, having a filing date of Oct. 11, 2007, which is incorporated herein by reference in its entirety.

### FEDERALLY SPONSORED RESEARCH OR DEVELOPMENT

[Not Applicable]

### MICROFICHE/COPYRIGHT REFERENCE

[Not Applicable]

### FIELD OF THE INVENTION

The present invention relates to a gaming system, a method of gaming, a game controller and computer program code.

### BACKGROUND OF THE INVENTION

It is known to provide a gaming system which comprises a game controller arranged to select a stopping position for each of a plurality of reels to thereby randomly display several symbols from each reels at respective ones of a plurality of display positions. The game controller will then determine whether to make an award based on the displayed symbols. Such gaming systems may commonly be implemented as a stepper machine provided with mechanical reels with each reel carrying a set of symbols, or a video machine wherein symbols are displayed as virtual reels on a video display.

While such gaming systems provide users with enjoyment, a need exists for alternative gaming systems in order to maintain or increase player enjoyment.

### SUMMARY OF THE INVENTION

In a first aspect, the invention provides a method of gaming comprising:
providing a plurality of display positions;
selecting a plurality of symbols for display at the display positions;
evaluating the symbols to determine whether to make a first award based on a designated number of a designated symbol in a winning combination such that the first award is independent of the positions of the designated symbols in the winning combination; and
upon a prize being awarded in respect of a winning combination, evaluating the symbols of the winning combination to determine whether to make a second, additional award based on the arrangement of the designated symbols within the winning combination.

In an embodiment, the method comprises providing at least one win line playable by a player, each at least one win line corresponding to a plurality of the display positions, and evaluating whether there is a winning combination on each win line played by the player.

In an embodiment, there are a plurality of win lines, each corresponding to a different plurality of display positions.

In an embodiment, subsets of the plurality of display positions correspond to respective ones a plurality of reels and each win line comprises a display position of each reel.

In an embodiment, the method comprises receiving a player selection at least one win line.

In an embodiment, each first award is a prize amount.

In an embodiment, each second award comprises a prize amount.

In an embodiment, each second award comprises a multiplier.

In an embodiment, each second award comprises a jackpot increment.

In an embodiment, the first and second awards are awarded to the player as a single prize.

In a second aspect, the invention provides a game controller arranged to:
provide a plurality of display positions;
select a plurality of symbols for display at the display positions;
evaluate the symbols to determine whether to make a first award based on a designated number of a designated symbol in a winning combination such that the first award is independent of the positions of the designated symbols in the winning combination; and
upon a prize being awarded in respect of a winning combination, evaluate the symbols of the winning combination to determine whether to make a second, additional award based on the arrangement of the designated symbols within the winning combination.

In an embodiment, the game controller comprises a first award evaluator to determine whether to make the first award and a second prize evaluator arranged to determine whether to make the second award.

In an embodiment, the game controller is arranged to provide at least one win line playable by a player, each at least one win line corresponding to a plurality of the display positions, and evaluating whether there is a winning combination on each win line played by the player.

In an embodiment, there are a plurality of win lines, each corresponding to a different plurality of display positions.

In an embodiment, subsets of the plurality of display positions correspond to respective ones a plurality of reels and each win line comprises a display position of each reel.

In an embodiment, the game controller is arranged to receive a player selection of at least one win line.

In an embodiment, the first and second awards are awarded to the player as a single prize.

In an embodiment, the game controller is implemented by a processor executing program code stored in a memory.

In a third aspect, the invention provides a gaming system comprising:
a player interface comprising a display; and
a game controller arranged to:
   control the display to display a plurality of display positions;
   select a plurality of symbols for display at the display positions;
   evaluate the symbols to determine whether to make a first award based on a designated number of a designated symbol in a winning combination such that the first award is independent of the positions of the designated symbols in the winning combination; and
   upon a prize being awarded in respect of a winning combination, evaluate the symbols of the winning combination to determine whether to make a second, additional award based on the arrangement of the designated symbols within the winning combination.

In an embodiment, the game controller is arranged to provide at least one win line playable by a player, each at least one win line corresponding to a plurality of the display positions, and evaluating whether there is a winning combination on each win line played by the player.

In an embodiment, there are a plurality of win lines, each corresponding to a different plurality of display positions.

In an embodiment, subsets of the plurality of display positions correspond to respective ones a plurality of reels and each win line comprises a display position of each reel.

In an embodiment, the gaming system comprises an instruction input mechanism operable by the player to make a player selection of at least one win line.

In an embodiment, the first and second awards are awarded to the player as a single prize.

In a fourth aspect, the invention provides a method of gaming comprising:
providing a plurality of display positions;
selecting a plurality of symbols for display at the display positions;
evaluating the symbols to determine whether to make an award to a player based on a designated number of a designated symbol in a winning combination and whether to modify the award based on the arrangement of the designated symbols within the winning combination; and
making the award or the modified award to the player.

In a fifth aspect, the invention provides a game controller arranged to:
provide a plurality of display positions;
select a plurality of symbols for display at the display positions;
evaluate the symbols to determine whether to make an award to the player based on a designated number of a designated symbol in a winning combination and whether to modify the award based on the arrangement of the designated symbols within the winning combination; and
make the award or the modified award to the player.

In an embodiment, the game controller is implemented by a processor executing program code stored in a memory.

In a sixth aspect, the invention provides a gaming system comprising:
a player interface comprising a display; and
a game controller arranged to:
   control the display to display a plurality of display positions;
   select a plurality of symbols for display at the display positions;
evaluate the symbols to determine whether to make an award to the player based on a designated number of a designated symbol in a winning combination and whether to modify the award based on the arrangement of the designated symbols within the winning combination; and
make the award or the modified award to the player.

In a seventh aspect, the invention provides computer program code which when executed by a processor implements one or both of the above methods.

In an eighth aspect the invention provides a computer readable medium comprising the program code.

In a ninth aspect, the invention provides a data signal comprising the program code.

In a tenth aspect, the invention extends to transmitting program code.

### BRIEF DESCRIPTION OF THE DRAWINGS

A embodiment of the invention will now be described in relation to the following drawings in which:

FIG. 1 is a block diagram of the core components of a gaming system;

FIG. 2 is a perspective view of a gaming machine;

FIG. 3 is a block diagram of the functional components of a gaming machine;

FIG. 4 is a block diagram representing the structure of a memory;

FIG. 5 is a diagram schematic of a networked gaming system;

FIG. 6 is a further block diagram of the gaming system; and

FIG. 7 is a flowchart of a embodiment.

### DETAILED DESCRIPTION

The embodiment provides a gaming system having a gaming controller arranged to implement a method of gaming. The gaming controller is arranged to provide a plurality of display positions and select a plurality of symbols for display at the display positions. The symbols are evaluated to determine whether to make a first award based on a designated number of a designated symbol in a winning combination such that the first award is independent of the positions of the designated symbols, and if a prize is awarded, evaluating the symbols to determine whether to make a second, additional award based on the arrangement of the designated symbols in the winning combination. Typically the second award will be a modification of the first award such that a single prize amount is awarded to the player. The gaming system may be provided in a number of different forms.

In a first form, a stand alone gaming machine is provided wherein all or most components required for implementing the game are present in a player operable gaming machine.

In a second form, a distributed architecture is provided wherein some of the components required for implementing the game are present in a player operable gaming machine and some of the components required for implementing the game are located remotely relative to the gaming machine. For example, a “thick client” architecture may be used wherein part of the game is executed on a player operable gaming machine and part of the game is executed remotely, such as by a gaming server; or a “thin client” architecture may be used wherein most of the game is executed remotely such as by a gaming server and a player operable gaming machine is used only to display audible and/or visible gaming information to the player and receive gaming inputs from the player.

However, it will be understood that other arrangements are envisaged. For example, an architecture may be provided wherein a gaming machine is networked to a gaming server and the respective functions of the gaming machine and the gaming server are selectively modifiable. For example, the gaming system may operate in stand alone gaming machine mode, “thick client” mode or “thin client” mode depending on the game being played, operating conditions, and so on. Other variations will be apparent to persons skilled in the art.

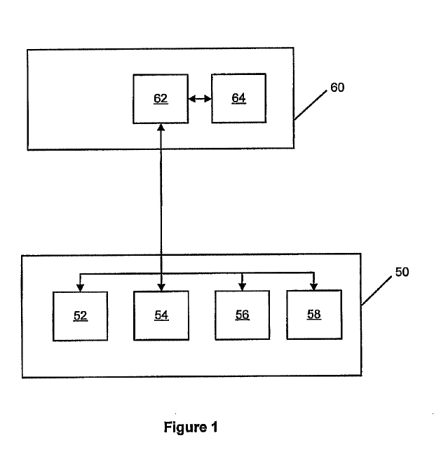

Irrespective of the form, the gaming system has several core components. At the broadest level, the core components are a player interface 50 and a game controller 60 as illustrated in FIG. 1. The player interface is arranged to enable manual interaction between a player and the gaming system and for this purpose includes the input/output components required for the player to enter instructions and play the game.

Components of the player interface may vary from embodiment to embodiment but will typically include a credit mechanism 52 to enable a player to input credits and receive payouts, one or more displays 54, a game play mechanism 56 that enables a player to input game play instructions, and a speaker 58 for audio outputs.

The game controller 60 is in data communication with the player interface and typically includes a processor 62 that processes the game play instructions in accordance with game play rules and outputs game play outcomes to the display. Typically, the game play instructions are stored as program code in a memory 64 but can also be hardwired. Herein the term “processor” is used to refer generically to any device that can process game play instructions in accordance with game play rules and may include: a microprocessor, microcontroller, programmable logic device or other computational device, a general purpose computer (e.g. a PC) or a server.

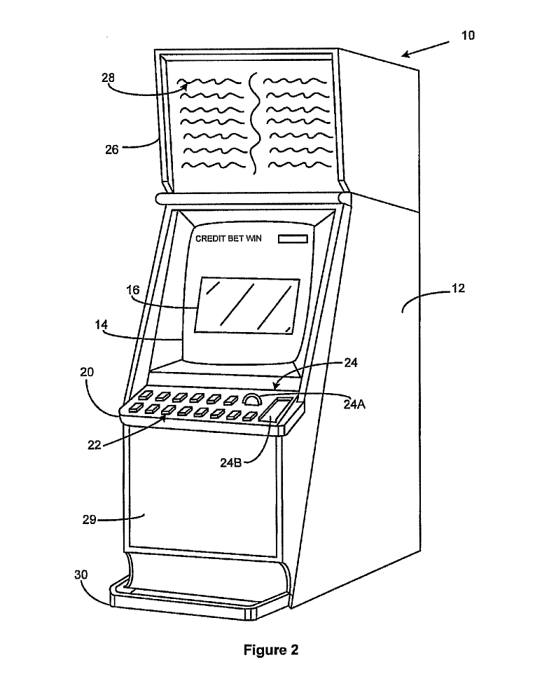

A gaming system in the form of a stand alone gaming machine 10 is illustrated in FIG. 2. The gaming machine 10 includes a console 12 having a display 14 on which is displayed representations of a game 16 that can be played by a player. A mid-trim 20 of the gaming machine 10 houses a bank of buttons 22 for enabling a player to interact with the gaming machine, in particular during game play. The mid-trim 20 also houses a credit input mechanism 24 which in this example includes a coin input chute 24A and a bill collector 24B. Other credit input mechanisms may also be employed, for example, a card reader for reading a smart card, debit card or credit card. A player marketing module having a reading device may also be provided for the purpose of reading a player tracking device, for example as part of a loyalty program. The player tracking device may be in the form of a card, flash drive or any other portable storage medium capable of being read by the reading device.

A top box 26 may carry artwork 28, including for example pay tables and details of bonus awards and other information or images relating to the game. Further artwork and/or information may be provided on a front panel 29 of the console 12. A coin tray 30 is mounted beneath the front panel 29 for dispensing cash payouts from the gaming machine 10.

The display 14 shown in FIG. 2 is in the form of a video display unit, particularly a cathode ray tube screen device. Alternatively, the display 14 may be a liquid crystal display, plasma screen, any other suitable video display unit, or the visible portion of an electromechanical device. The top box 26 may also include a display, for example a video display unit, which may be of the same type as the display 14, or of a different type.

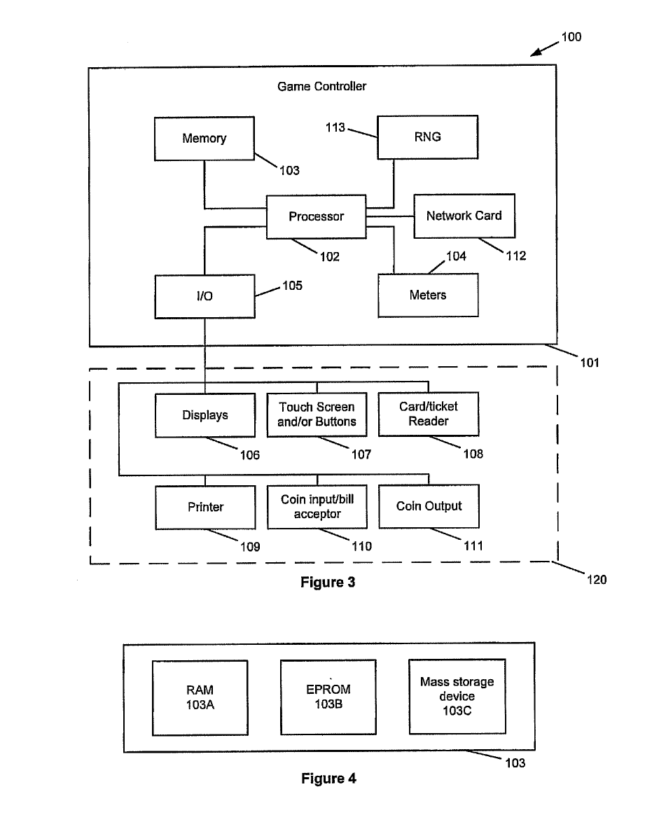

FIG. 3 shows a block diagram of operative components of a typical gaming machine which may be the same as or different to the gaming machine of FIG. 2.

The gaming machine 100 includes a game controller 101 having a processor 102. Instructions and data to control operation of the processor 102 are stored in a memory 103, which is in data communication with the processor 102. Typically, the gaming machine 100 will include both volatile and non-volatile memory and more than one of each type of memory, with such memories being collectively represented by the memory 103.

The gaming machine has hardware meters 104 for purposes including ensuring regulatory compliance and monitoring player credit, an input/output (I/O) interface 105 for communicating with peripheral devices of the gaming machine 100. The input/output interface 105 and/or the peripheral devices may be intelligent devices with their own memory for storing associated instructions and data for use with the input/output interface or the peripheral devices. A random number generator module 113 generates random numbers for use by the processor 102. Persons skilled in the art will appreciate that the reference to random numbers includes pseudo-random numbers.

In the example shown in FIG. 3, a player interface 120 includes peripheral devices that communicate with the game controller 101 including one or more displays 106, a touch screen and/or buttons 107, a card and/or ticket reader 108, a printer 109, a bill acceptor and/or coin input mechanism 110 and a coin output mechanism 111. Additional hardware may be included as part of the gaming machine 100, or hardware may be omitted as required for the specific implementation.

In addition, the gaming machine 100 may include a communications interface, for example a network card 112. The network card may, for example, send status information, accounting information or other information to a central controller, server or database and receive data or commands from the central controller, server or database.

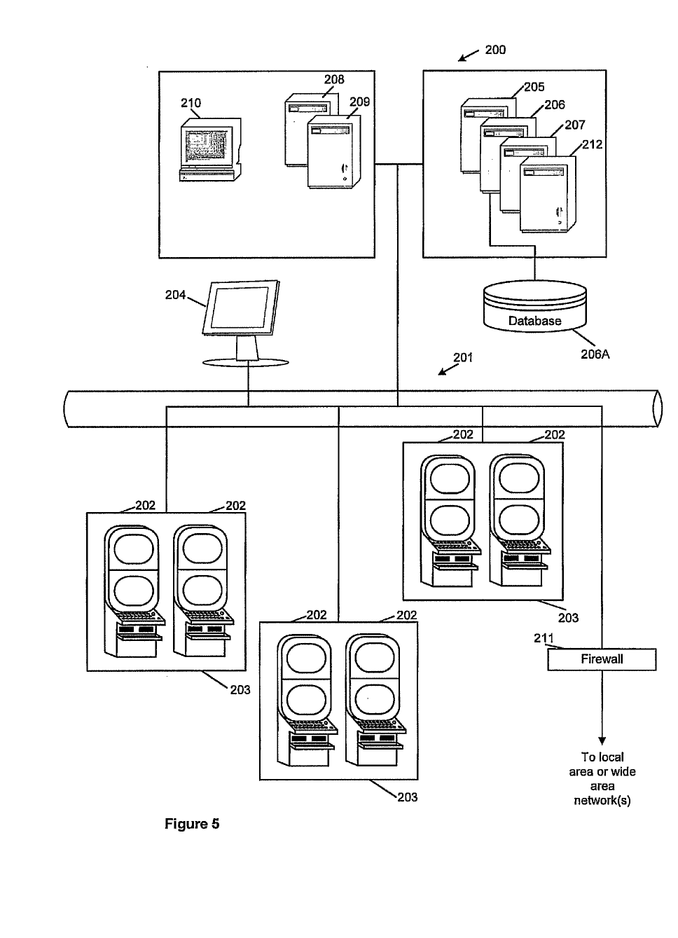

FIG. 4 shows a block diagram of the main components of an exemplary memory 103. The memory 103 includes RAM 103A, EPROM 103B and a mass storage device 103C. The RAM 103A typically temporarily holds program files for execution by the processor 102 and related data. The EPROM 103B may be a boot ROM device and/or may contain some system or game related code. The mass storage device 103C is typically used to store game programs, the integrity of which may be verified and/or authenticated by the processor 102 using protected code from the EPROM 103B or elsewhere.

It is also possible for the operative components of the gaming machine 100 to be distributed, for example input/output devices 106,107,108,109,110,111 to be provided remotely from the game controller 101.

FIG. 5 shows a gaming system 200 in accordance with an alternative embodiment. The gaming system 200 includes a network 201, which for example may be an Ethernet network. Gaming machines 202, shown arranged in three banks 203 of two gaming machines 202 in FIG. 5, are connected to the network 201. The gaming machines 202 provide a player operable interface and may be the same as the gaming machines 10,100 shown in FIGS. 2 and 3, or may have simplified functionality depending on the requirements for implementing game play. While banks 203 of two gaming machines are illustrated in FIG. 5, banks of one, three or more gaming machines are also envisaged.

One or more displays 204 may also be connected to the network 201. The displays 204 may, for example, be associated with one or more banks 203 of gaming machines. The displays 204 may be used to display representations associated with game play on the gaming machines 202, and/or used to display other representations, for example promotional or informational material.

In a thick client embodiment, game server 205 implements part of the game played by a player using a gaming machine 202 and the gaming machine 202 implements part of the game. With this embodiment, as both the game server and the gaming device implement part of the game, they collectively provide a game controller. A database management server 206 may manage storage of game programs and associated data for downloading or access by the gaming devices 202 in a database 206A. Typically, if the gaming system enables players to participate in a Jackpot game, a Jackpot server 207 will be provided to carry out the accounting in respect of the Jackpot game. A loyalty program server 212 may also be provided.

In a thin client embodiment, game server 205 implements most or all of the game played by a player using a gaming machine 202 and the gaming machine 202 essentially provides only the player interface. With this embodiment, the game server 205 provides the game controller. The gaming machine will receive player instructions, pass these to the game server which will process them and return game play outcomes to the gaming machine for display. In a thin client embodiment, the gaming machines could be computer terminals, e.g. PCs running software that provides a player interface operable using standard computer input and output components.

Servers are also typically provided to assist in the administration of the gaming network 200, including for example a gaming floor management server 208, and a licensing server 209 to monitor the use of licenses relating to particular games. An administrator terminal 210 is provided to allow an administrator to run the network 201 and the devices connected to the network.

The gaming system 200 may communicate with other gaming systems, other local networks, for example a corporate network, and/or a wide area network such as the Internet, for example through a firewall 211.

Persons skilled in the art will appreciate that in accordance with known techniques, functionality at the server side of the network may be distributed over a plurality of different computers. For example, elements may be run as a single “engine” on one server or a separate server may be provided. For example, the game server 205 could run a random generator engine. Alternatively, a separate random number generator server could be provided. Further, persons skilled in the art will appreciate that a plurality of game servers could be provided to run different games or a single game server may run a plurality of different games as required by the terminals.

The embodiment may be implemented in relation to a spinning reel type game. Gaming systems for implementing games that involve a display of spinning reels as part of the display of the outcome of a game have either a video display or a mechanical display, these later machines most usually being “stepper” machines which have a separate motor for each reel. However, persons skilled in the art will appreciate that the invention can be implemented in respect if other forms of games, including card games and dice games.

The game controller of a spinning reel type game may select symbols for display at a plurality of stop positions by employing a stop determining function that randomly determines the stop position for each reel. For example, if there are five reels, each having twenty symbols, the stop determining function might determine that the stop positions are positions: 3, 13, 7, 9 and 17 which correspond to symbols of each reel. The spinning of the reels is then controlled so that each symbol comes to a stop in the same row, typically a predetermined row in a “window” visible to the player on the display that which corresponds to a player playing a single win line. When a reel stops, the symbols will be in one of a plurality of possible symbol positions for that reel relative to the stop position.

Spinning reel type games typically allow a player to select how many win lines of a plurality of win lines they will play in each game—i.e. a minimum of one win line up to the maximum number of win lines allowed by the game, although often not all variations are presented as options to the player. For example, the player might be offered 1, 2, 3, 5, 10, 15 and 25 win lines. Persons, skilled in the art, will appreciate that in other embodiments, the player may select a number of reels to play. Each win line is formed by a set of symbol positions having one symbol position from each reel. That is, a symbol position of each reel is assigned to a win line. The symbol positions that constitute each of the win lines are usually advertised to the player by markings on the display or diagrams showing the symbol positions that correspond to each win line. A game outcome is determined based on the symbols on the win lines and a prize table that specifies awards.

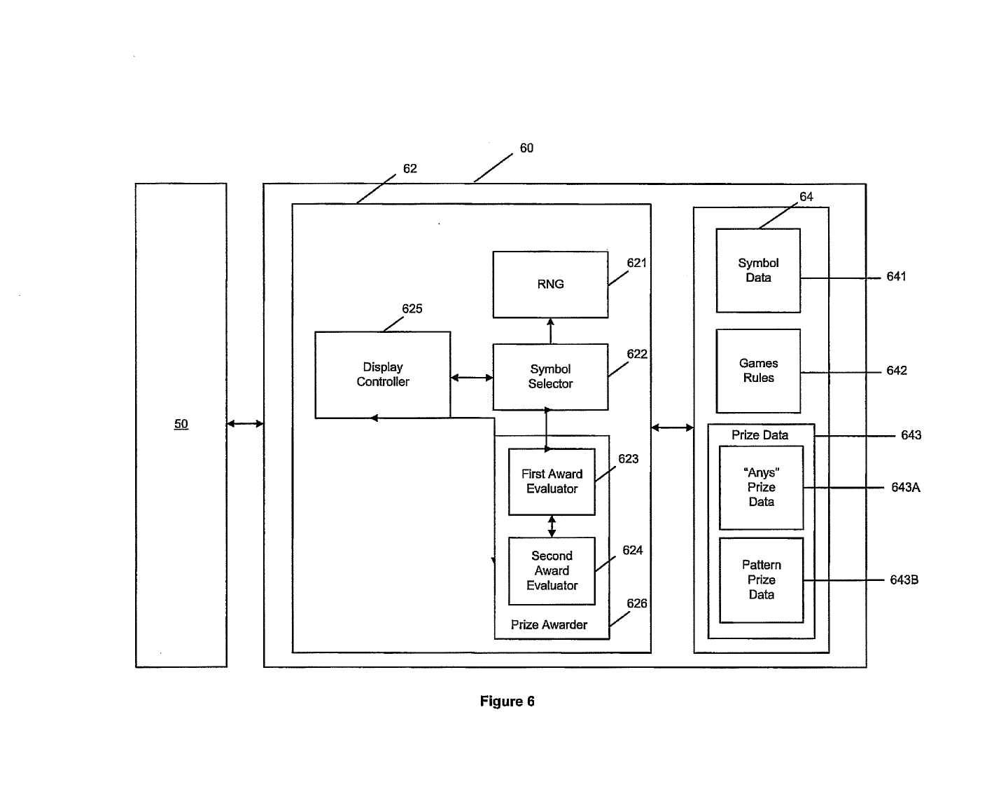

The game controller 60 of the embodiment is shown in more detail in FIG. 6. It will apparent that the processor 62 implements a number of modules, namely random number generator module 621, symbol selector 622, first award evaluator 623, second award evaluator 624 and display controller 625 based on data stored in memory 64. Persons skilled in the art will appreciate that not all modules need be implemented by processor 62. For example, the random number generator module 621 could be implemented by a separate circuit or by a random number generator server.

The symbol selector 622 selects symbols from symbol data 641 using the random number generator 621 in accordance with techniques known in the art and as described generally above. That is, the symbol selector in the case of a reel type game will select a stop position for each reel to thereby select the symbols which will appear on a plurality of display positions. In a typical embodiment there will be five reels and three display positions for each reel giving a total of fifteen display positions. Game rules 642 specifies the implications of particular selections, for example, if a feature is to be triggered. After the symbols are selected, they are displayed at the plurality of display positions under control of display controller 625.

A prize awarder 626 has a first award evaluator 623 determines where any “anys” prizes should be awarded based on “any” prize data 643A of prize data 643. “Anys” prizes are prizes awarded based solely on the number of a symbol in a winning combination on a win line played by a player, for example, three, four or five of a particular symbol. If a first prize is awarded, the second award evaluator 624 determines whether to make a second award based on the arrangement of the designated symbols along the win line as specified in pattern prize data 643B. Depending on the embodiment, these arrangements may be relative arrangements of display positions (e.g. three in a row) or absolute arrangements of display positions (e.g. the first three display positions). Depending on the embodiment, the second award may be a modification of the first award (e.g. a multiplier, in which case it will be appreciated that the player is in effect made a single award of a prize amount), an additional award amount, or a separate award (e.g. in the form of a jackpot contribution).

Depending on the embodiment, the awards may be displayed to the user as a single prize or separate prizes. In one example, the player may be advised that they have won 50 credits for three Aces and separately advised that the prize is multiplied by three because the Aces are next to one another. In another example, the player could just be displayed a total award of 150 credits.

An example of a pattern is the paying symbols all being adjacent to one another or occupying reels one, two and three.

While it is described above, that the winning combination occurs on a win line, it will be appreciated that in other embodiments other winning combinations may be identified based on a number of designated symbols and the second award may be made based on the arrangement of the symbols within the winning combination.

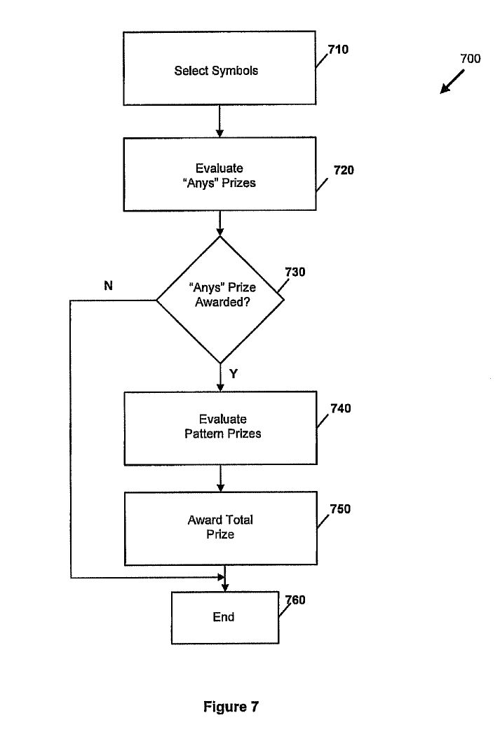

The method 700 of the embodiment is summarized in FIG. 7, the symbols are selected 710 and the “anys” prizes are evaluated 720. It is then determined whether any “anys” prizes are awarded 730. If “anys” prizes are awarded the pattern prizes are evaluated 740 and a total prize is awarded 750 before game ends 760.

### EXAMPLE

In an example, all pays in a game are any type pays. A player plays three lines for a total cost of three dollars. A player presses a spin button and the symbol selector of the game controller selects stop positions for the reels. When three or more of any symbol appear on a win line in any order, a pay is awarded. A secondary evaluation is then made based on the positions/patterns of the paying symbols. In this example, if the paying symbols are all adjacent to each other then the pay is tripled. If the paying symbols are all adjacent and on reels one, two and three, the pay is multiplied by five. Further, each picture symbol may represent a stand alone or link jackpot such that when a pay occurs on a picture symbol, an award is made by incrementing a jackpot meter by an arbitrary amount in addition to the player winning the tripled pay amount.

It will be understood to persons skilled in the art of the invention that many modifications may be made without departing from the spirit and scope of the invention.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be understood that, if any prior art publication is referred to herein, such reference does not constitute an admission that the publication forms a part of the common general knowledge in the art in any country.

1. A method of gaming comprising:
providing a plurality of display positions;
selecting a plurality of symbols for display at the display positions;
evaluating the symbols to determine whether to make a first award based on a designated number of a designated symbol in a winning combination such that the first award is independent of the positions of the designated symbols in the winning combination; and
upon a prize being awarded in respect of a winning combination, evaluating the symbols of the winning combination to determine whether to make a second, additional award based on the arrangement of the designated symbols within the winning combination.

2. A method as claimed in claim 1, comprising providing at least one win line playable by a player, each at least one win line corresponding to a plurality of the display positions, and evaluating whether there is a winning combination on each win line played by the player.

3. A method as claimed in claim 2, wherein there are a plurality of win lines, each corresponding to a different plurality of display positions.

4. A method as claimed in claim 2, wherein subsets of the plurality of display positions correspond to respective ones a plurality of reels and each win line comprises a display position of each reel.

5. A method as claimed in claim 2, comprising receiving a player selection at least one win line.

6. A method as claimed in claim 1, wherein each first award is a prize amount.

7. A method as claimed in claim 1, wherein each second award comprises a prize amount.

8. A method as claimed in claim 1, wherein each second award comprises a multiplier.

9. A method as claimed in claim 1, wherein each second award comprises a jackpot increment.

10. A method as claimed in claim 1, wherein the first and second awards are awarded to the player as a single prize.

11. A game controller arranged to:
provide a plurality of display positions;
select a plurality of symbols for display at the display positions;
evaluate the symbols to determine whether to make a first award based on a designated number of a designated symbol in a winning combination such that the first award is independent of the positions of the designated symbols in the winning combination; and
upon a prize being awarded in respect of a winning combination, evaluate the symbols of the winning combination to determine whether to make a second, additional award based on the arrangement of the designated symbols within the winning combination.

12. A game controller as claimed in claim 11, comprising a first award evaluator to determine whether to make the first award and a second prize evaluator arranged to determine whether to make the second award.

13. A game controller as claimed in claim 10, arranged to provide at least one win line playable by a player, each at least one win line corresponding to a plurality of the display positions, and evaluating whether there is a winning combination on each win line played by the player.

14. A game controller as claimed in claim 13, wherein there are a plurality of win lines, each corresponding to a different plurality of display positions.

15. A game controller as claimed in claim 13, wherein subsets of the plurality of display positions correspond to respective ones a plurality of reels and each win line comprises a display position of each reel.

16. A game controller as claimed in claim 11, arranged to receive a player selection of at least one win line.

17. A game controller as claimed in claim 11, wherein the first and second awards are awarded to the player as a single prize.

18. A game controller as claimed in claim 11, implemented by a processor executing program code stored in a memory.

19. A gaming system comprising:
a player interface comprising a display; and
a game controller arranged to:
control the display to display a plurality of display positions;
select a plurality of symbols for display at the display positions;
evaluate the symbols to determine whether to make a first award based on a designated number of a designated symbol in a winning combination such that the first award is independent of the positions of the designated symbols in the winning combination; and
upon a prize being awarded in respect of a winning combination, evaluate the symbols of the winning combination to determine whether to make a second, additional award based on the arrangement of the designated symbols within the winning combination.

20. A gaming system as claimed in claim 19, wherein the game controller is arranged to provide at least one win line playable by a player, each at least one win line corresponding to a plurality of the display positions, and evaluating whether there is a winning combination on each win line played by the player.

21. A gaming system as claimed in claim 20, wherein there are a plurality of win lines, each corresponding to a different plurality of display positions.

22. A gaming system as claimed in claim 20, wherein subsets of the plurality of display positions correspond to respective ones a plurality of reels and each win line comprises a display position of each reel.

23. A gaming system as claimed in claim 19, comprising an instruction input mechanism operable by the player to make a player selection of at least one win line.

24. A gaming system as claimed in claim 19, wherein the first and second awards are awarded to the player as a single prize.

25. A method of gaming comprising:
providing a plurality of display positions;
selecting a plurality of symbols for display at the display positions;
evaluating the symbols to determine whether to make an award to a player based on a designated number of a designated symbol in a winning combination and whether to modify the award based on the arrangement of the designated symbols within the winning combination; and
making the award or the modified award to the player.

26. A game controller arranged to:
provide a plurality of display positions;
select a plurality of symbols for display at the display positions;
evaluate the symbols to determine whether to make an award to the player based on a designated number of a designated symbol in a winning combination and whether to modify the award based on the arrangement of the designated symbols within the winning combination; and
make the award or the modified award to the player.

27. A game controller as claimed in claim 26, implemented by a processor executing program code stored in a memory.

28. A gaming system comprising:
a player interface comprising a display; and
a game controller arranged to:
control the display to display a plurality of display positions;
select a plurality of symbols for display at the display positions;
evaluate the symbols to determine whether to make an award to the player based on a designated number of a designated symbol in a winning combination and whether to modify the award based on the arrangement of the designated symbols within the winning combination; and
make the award or the modified award to the player.

29. Computer program code which when executed implements the method of claim 1.

30. A computer readable medium comprising the computer program code of claim 29.

31. A data signal comprising the computer program code of claim 29.

32. Transmitting the computer program code of claim 29.
